(19) United States
(12) Patent Application Publication
(10) Pub. No.: US 2012/0174001 A1
(43) Pub. Date: Jul. 5, 2012

(54) GRAPHICALLY BASED HIERARCHICAL METHOD FOR DOCUMENTING ITEMS OF EVIDENCE GENEALOGY

(76) Inventors: Itschak Friedman, Hollywood, FL (US); Robin Gall, Plantation, FL (US)

(21) Appl. No.: 12/983,171

(22) Filed: Dec. 31, 2010

(51) Int. Cl. G06F 3/048

(52) U.S. Cl. 715/763

(57) ABSTRACT

A computer readable memory medium comprising program instructions for documenting an evidence packaging structure is provided. The program instructions are executable by a processor to generate a graphical diagram in response to user input. The graphical diagram includes a root node representing an outermost evidence storage unit, and a leaf node of the root node representing an item of evidence, wherein the item of evidence is located within the evidence storage unit.

### FIELD OF THE INVENTION

The present invention relates generally a method for documenting items of evidence. In particular, the invention relates to a graphically based hierarchical method for documenting items of evidence genealogy.

### BACKGROUND

A Laboratory Information Management System or Laboratory Integration Management Solution (LIMS) is a software system used in laboratories for the integration of laboratory software and instruments and the management of samples, laboratory users, standards and other laboratory functions such as Quality Assurance (QA) and Quality Control (QC), sample planning, invoicing, plate management, and workflow automation. LIMS implementations may also support information gathering, decision making, calculation, review and release into the workplace and away from the office. More recently, LIMS products are starting to expand into Electronic Laboratory Notebooks, assay data management, data mining and data analysis.

One core function of LIMS is the management of samples. This typically is initiated when a sample is received in the laboratory at which point the sample will be registered in the LIMS. This registration process may involve accessioning the sample and producing barcodes to affix to the sample container. Various other parameters may be recorded as well, such as clinical or phenotypic information corresponding with the sample. The LIMS may then track chain of custody of the sample as well as the sample location. Location tracking often involves assigning the sample to a particular location such as a shelf/rack/box/row/column. Other event tracking may be required such as freeze and thaw cycles that a sample undergoes in the laboratory.

Modern LIMS have implemented extensive configurability as each laboratories needs for tracking additional data points can vary widely. LIMS vendors often cannot make assumptions about what these data tracking needs are and therefore need to be adaptable to each environment. LIMS users may also have regulatory concerns to comply with such as CLIA, HIPAA, GLP, ISO 17025, ASCLD Supplement, and FDA specifications and this can affect certain aspects of sample management in a LIMS solution. One key to compliance with many of these standards is audit logging of all changes to LIMS data, and in some cases a full electronic signature system is required for rigorous tracking of field level changes to LIMS data.

One may configure a LIMS whereby users are assigned roles or groups. Typically the role of a user will dictate their access to specific data records in the LIMS. Each user account is protected by security mechanisms such as a user id and a password. Users may have customized interfaces based on their role in the organization. For example, a laboratory manager might have full access to all of a LIMS functions and data, whereas technicians might have access only to data and functionality needed for their individual work-tasks.

Some LIMS offer some capability for integration with instruments. A LIMS may create control files that are “fed” into the instrument and direct its operation on some physical item such as a sample tube or sample plate. The LIMS may then import instrument results files to extract QC or results data for assessment of the operation on the sample or samples. Data owners may access the resulting stored information at any time.

A LIMS may be customized for use in a wide variety of settings, such as medical or clinical laboratories, biological laboratories, chemistry laboratories, chemical or petroleum laboratories, commercial or manufacturing use, forensics or crime laboratories, pathology laboratories, public safety and public health laboratories, and water processing and testing facilities.

A forensics laboratory is a scientific laboratory, using primarily forensic science for the purpose of examining evidence from criminal cases. Typically, once evidence is collected at a crime scene, the collected evidence is then brought back to a forensics laboratory for analyses. The evidence must be properly managed from the time it is collected at the crime scene until the time it is presented at court. The administration and control of evidence related to an event so that it can be used to prove the circumstances of the event, is called evidence management. Proper evidence management allows for the evidence to be tested by independent parties with confidence that the evidence provided is the evidence collected related to the event. The proper management of evidence is so important to forensics laboratories responsible for evidence that formal standards have been developed for the management, administration, and handling of evidence. The failure to apply proper standards to property processing can result in the evidence not being able to be admitted at trial.

With reference to FIG. 5, items of evidence 222 are often brought to a forensics laboratory sealed within a physical container called an outermost evidence storage unit 210. The evidence storage unit 210 could be as simple as a bag or envelope or as elaborate as a large container, a briefcase, or box. Typically, the evidence storage unit 210 is of a size and shape that it is able to be handled by a single person. Small items of evidence 222 can be placed in an “evidence bag,” which is a plastic bag with special tamper resistant features and places to record the chain of custody. Large items of evidence 222 may require a larger evidence storage unit 210 able to be handled using a fork lift. The evidence storage unit 210 performs a number of functions, including: 1) providing physical stability of the evidence; 2) providing regular and organized stacking and placement to allow optimal access of the evidence; and 3) protection of evidence management personnel from possible dangers inherent in the evidence.

Within the evidence storage unit 210, additional layers of inner storage units 220 may encompass the items of evidence 222, and additional items 224 which are not used as evidence, may be present in addition to the items of evidence 222. The outermost evidence storage unit 210, the location and order of additional layers of inner storage units 220 and the location and placement of any additional items 224, along with the items of evidence's 222 ultimate locations, all make up an evidence packaging structure 200. For example, items of evidence 222 submitted to a forensics laboratory may have an outer plastic bag used as the outermost evidence storage unit 210 and containing a label 212 detailing the items evidence 222 sealed within. Additional inner storage units 220 may be present within the outermost evidence storage unit 210, such as a purse or a briefcase, and within the additional inner evidence storage units 220 there may be a list of additional items 224 in addition to the items of evidence 222, which may be located within a certain location within the inner evidence storage units 220. All of this information makes up the evidence packaging structure 200 and must be recorded so that proper evidence management may be maintained, and so that the integrity of the evidence does not come into question at a later point in time.

Forensics analysts working within the forensics laboratory many times need to be able to describe the complete evidence packaging structure 200, layer by layer in such detail so that they may be able to describe the evidence packaging structure 200 years later in court. The importance of documenting the evidence packaging structure 200 is touched on in the ASCLD (American Society of Crime Laboratory Directors) supplement to ISO/IEC 17025 in requirement 4.13.2.4-Note 2, which states that “The laboratory procedure shall identify what documents will be maintained in case records, . . . [and] may include, but is not limited to . . . descriptions of evidence packaging and seals.”

As a result of this requirement, it would be desirable to provide a LIMS for a forensics laboratory which provides forensic analysts with a means for documenting the complete evidence packaging structure so that a forensic analyst may be able to later describe the complete evidence packaging structure at some later date.

### SUMMARY

In one aspect, a computer readable memory medium comprising program instructions for documenting an evidence packaging structure is provided. The program instructions are executable by a processor to generate a graphical diagram in response to user input. The graphical diagram includes a root node representing an outermost evidence storage unit, and a leaf node of the root node representing an item of evidence, wherein the item of evidence is located within the evidence storage unit.

In one aspect, a method for documenting an evidence packaging structure is provided. The method includes inputting structural information for an outermost evidence storage unit and each interior evidence storage unit and each item of evidence within the outermost evidence storage unit into a computer readable memory medium. The method also includes accessing computer readable memory medium and generating, using a processor, a graphical diagram in response to the structural information. The graphical diagram includes a root node representing the outermost evidence storage unit, and a leaf node of the root node representing each item evidence within the outermost evidence storage.

In one aspect, a laboratory information management system for documenting an evidence packaging structure is provided. The system includes a computer readable memory medium and at least one processor operable to access from the computer readable memory medium program instructions executable by the processor. The program instructions are executable to receive structural information input by a user into the computer readable memory medium, the structural information describing the relationship between an outermost evidence storage unit and each interior evidence storage unit and each item of evidence within the outermost evidence storage unit. The program instructions are also executable to access the computer readable memory medium to retrieve the structural information, and generate a graphical diagram in response to the structural information. The graphical diagram includes a root node representing the outermost evidence storage unit and a leaf node of the root node representing each item evidence within the outermost evidence storage.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a block schematic diagram of an exemplary computing system, in accordance with one embodiment of the present invention.

FIG. 2 depicts flowchart illustrations of methods, apparatus (systems) and computer program products, in accordance with one embodiment of the present invention.

FIG. 3 depicts an illustration of a graphical diagram which represents an evidence packaging structure, in accordance with one embodiment of the present invention.

FIG. 4 depicts an illustration of an exhibit grid, in accordance with one embodiment of the present invention.

FIG. 5 depicts an illustration of an evidence packaging structure, in accordance with one embodiment of the present invention.

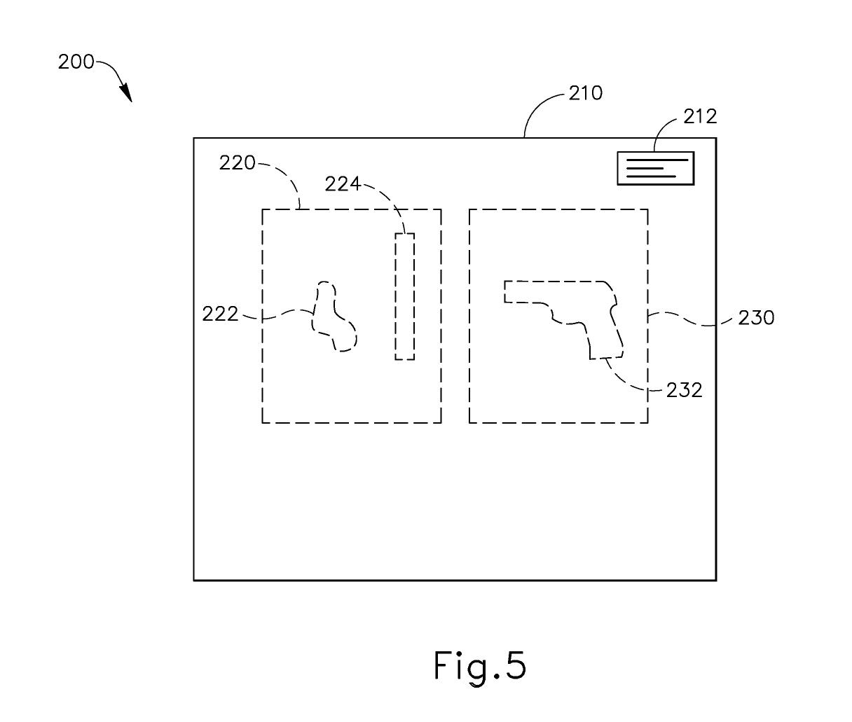

FIG. 6 depicts an illustration of a graphical diagram which represents an evidence packaging structure, in accordance with one embodiment of the present invention.

### DETAILED DESCRIPTION

The present invention makes use of the discovery that by providing a forensic analyst with software which can generate a graphical diagram which represents an evidence packaging structure along with linking portions of the graphical diagram to an exhibit grid, a complete evidence packaging structure can be recreated, providing a means for documenting the complete evidence packaging structure so that a forensic analyst may be able to later describe the complete evidence packaging structure at some later date.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

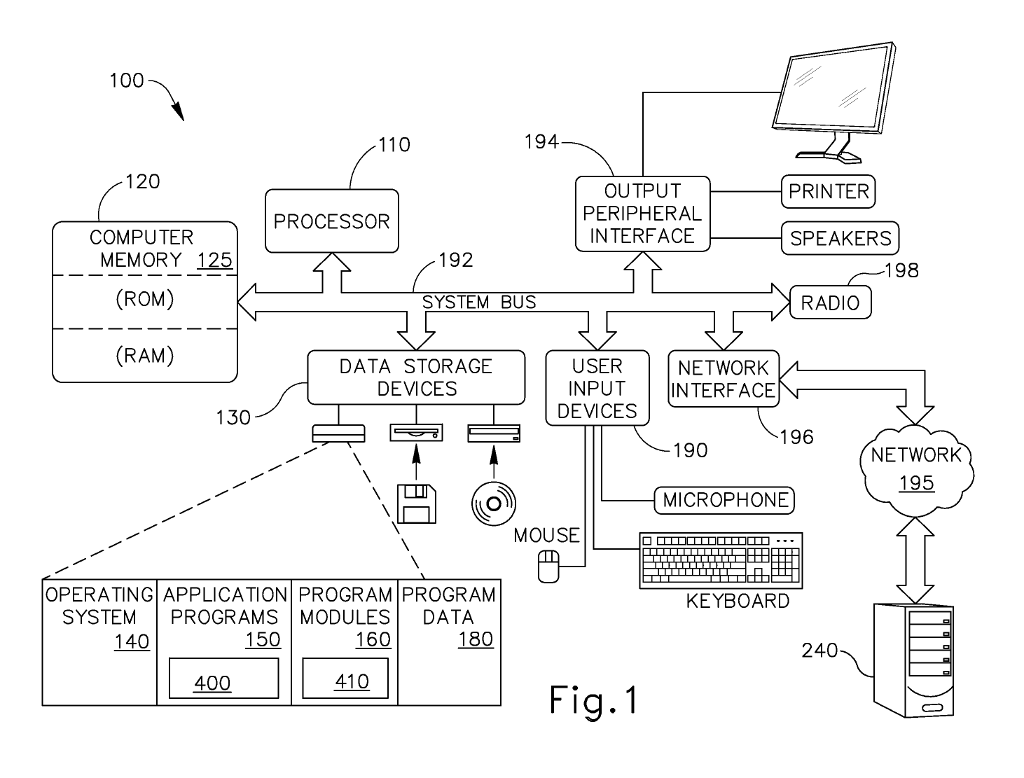

With reference to FIG. 1, depicted is an exemplary computing system for implementing embodiments. FIG. 1 includes computer 100 running software, such as LIMS software application 400. The computer 100 includes a processor 110 in communication with a computer readable memory medium 120. Computer readable memory medium 120 is any medium which can be used to store information which can later be accessed by processor 110. Computer readable memory medium 120 includes computer memory 125 and data storage devices 130. Computer memory 120 is preferably a fast-access memory and is used to run program instructions executable by the processor 110. Computer memory 120 includes random access memory (RAM), flash memory, and read only memory (ROM). Data storage devices 130 are preferably physical devices and are used to store any information which may be accessed by the processor 110, such as an operating system 140, application programs 150 such as LIMS software application 400, program modules 160 such as evidence documentation module 410 which runs as a part of LIMS software application 400, and program data 180. Data storage devices 130 and their associated computer readable memory medium provide storage of computer readable instructions, data structures, program modules and other data for the computer 100. Data storage devices 130 include magnetic medium like a floppy disk, a hard disk drive, and magnetic tape; an optical medium like a Compact Disc (CD), a Digital Video Disk (DVD), and a Blu-ray Disc; and solid state memory such as random access memory (RAM), flash memory, and read only memory (ROM).

Computer 100 further includes input devices 190 through which data may enter the computer 100, either automatically or by a user who enters commands and data. Input devices 190 can include an electronic digitizer, a flatbed scanner, a barcode reader, a microphone, a camera, a video camera, a keyboard and a pointing device, commonly referred to as a mouse, a trackball or a touch pad, a pin pad, any USB device, any Bluetooth enabled device, an RFID or NFC device, and a debit card reader. Other input devices may include a joystick, game pad, satellite dish, scanner, an instrument, a sensor, and the like. In one or more embodiments, input devices 190 are portable devices that can direct display or instantiation of applications running on processor 110.

These and other input devices 190 can be connected to processor 110 through a user input interface that is coupled to a system bus 192, but may be connected by other interface and bus structures, such as a parallel port, game port or a universal serial bus (USB). Computers such as computer 100 may also include other peripheral output devices such as speakers, printers, and/or display devices, which may be connected through an output peripheral interface 194 and the like.

Computer 100 also includes a radio 198 or other type of communications device for wirelessly transmitting and receiving data for the computer 100 with the aid of an antenna. Radio 198 may wirelessly transmit and receive data using WiMAX™, 802.11a/b/g/n, Bluetooth™, 2G, 2.5G, 3G, and 4G, wireless standards.

Computer 100 may operate in a networked environment 195 using logical connections to one or more remote computers, such as a remote server 240. The remote server 240 may be a personal computer, a server, a router, a network PC, a peer device or other common network node, and may include many if not all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN or WLAN through a network interface 196 or an adapter. When used in a WAN networking environment, computer 100 may include a modem or other means for establishing communications over the WAN, such as radio 198, to environments such as the Internet or to another remote computer. It will be appreciated that other means of establishing a communications link between computer 100 and other remote computers may be used.

In one embodiment, computer 100 is in communication with remote server 240, and the LIMS software application 400 is run on the remote server 240, receiving commands and information from the computer 100 being input by a user. Information from the LIMS software application 400 running on the remote server 240 is displayed on a display device connected with the computer 100.

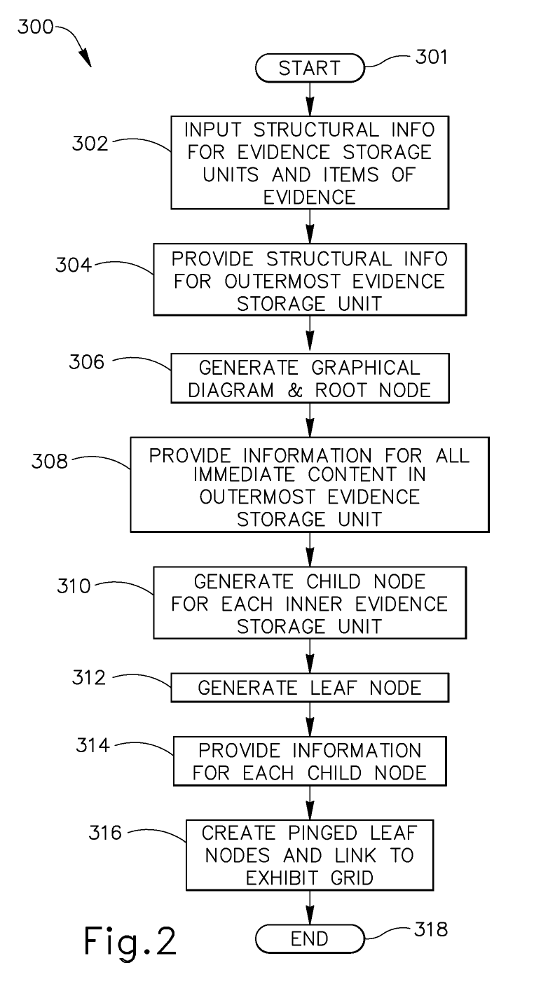

With reference to FIG. 2, a flowchart representation of a method 300 for documenting an evidence packaging structure 200 is provided. Method 300 is initiated at block 301 by launching LIMS software application 400 within the computer 100 or the remote server 240. Concurrent with the launching the LIMS software application 400, evidence documentation module 410 is also launched which resides within the LIMS software application 400. Upon Launching the LIMS software application 400, and within the evidence documentation module 410, the user may be first prompted to input structural information for an outermost evidence storage unit 210 and each interior evidence storage unit 220 and each item of evidence 222 within the outermost evidence storage unit 210 into a computer readable memory medium, at block 302. Structural information input by the user helps to describe the evidence packaging structure 200 beginning with describing the outermost evidence storage unit 210 and then going onto to provide a description of each interior evidence storage unit 220 and each item 222 and 224 within the outermost evidence storage unit 210. Structural information may include an exhibit ID 442 for each item 222 and 224, a description 444 of each item 222 and 224, repacking information 446 for each item 222 and 224, and item routing information for each item 222 and 224.

An exhibit ID is an identifying mark, number, or other piece of information, which identifies each item 222 and 224. Description 444 provides a brief a statement, picture in words, or account that describes each item 222 and 224. Repackaging information 446 details whether or not the item 222 and 224 was taken out of its original evidence storage unit 210 or 220 and then repacking and placed into another evidence storage unit 210 or 220. If the item 222 or 224 was repackaged, then the repackaging information 446 provides a description of how the item was repackaged and a description of which new evidence storage unit 210 or 220 the item 222 or 224 was placed in. Item routing information 448 details whether the item 222 or 224 was ever routed separately from the item 222 or 224's original evidence storage unit 210 or 220.

At block 304, the user is first prompted to provide structural information for the outermost evidence storage unit 210, preferably including, describing the information on label 212 of outermost evidence storage unit 210 along with the type of evidence storage unit that outermost evidence storage unit 210 is and the manner in which the outermost evidence storage unit 210 was sealed if at all. For example, structural information for the outermost evidence storage unit 210 may include information such as: a tape sealed evidence bag, a Ziploc™ bag, a fold style sandwich bag, a coin envelope, a tape sealed plastic container, a nailed shut wooden container, etc.

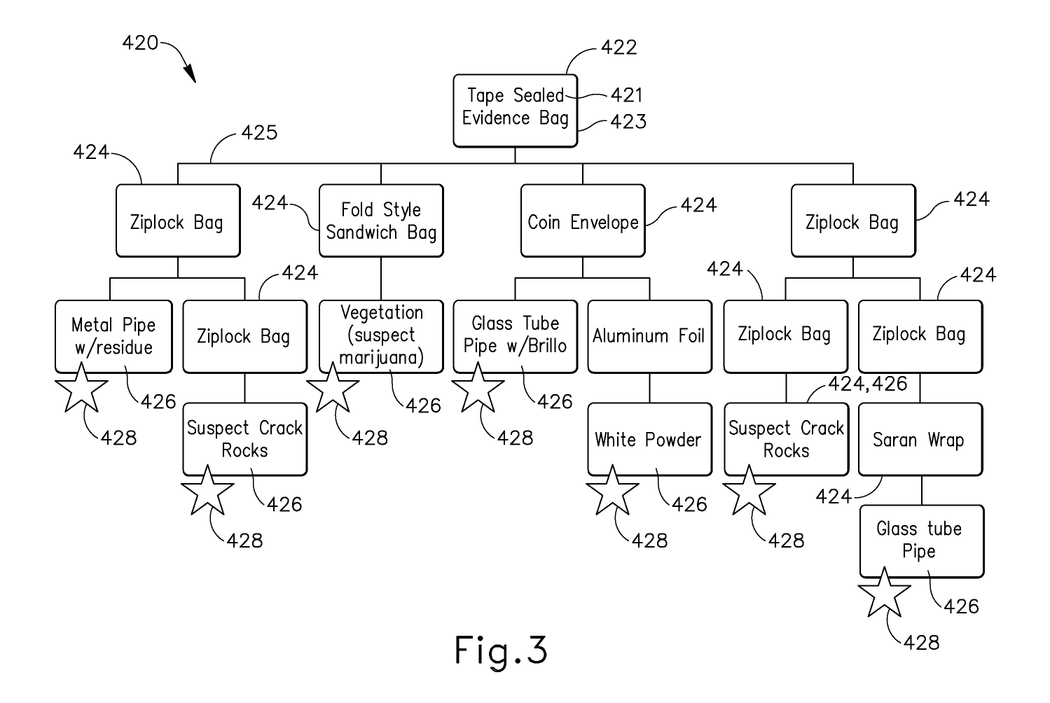

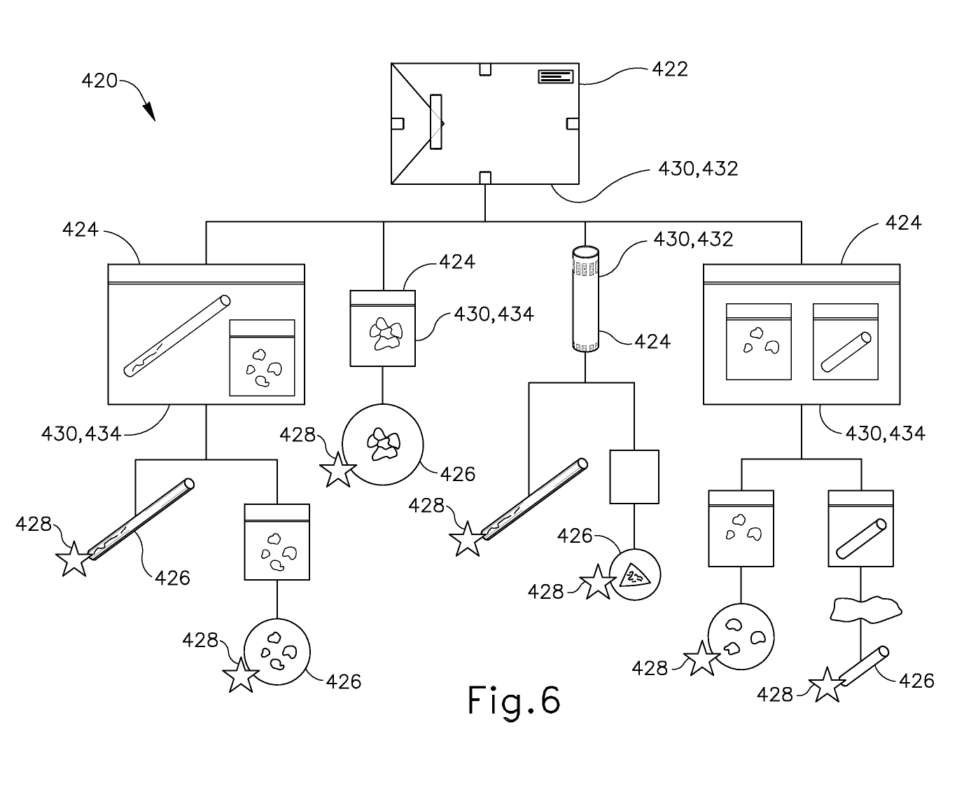

Moving to block 306, upon providing structural information for the outermost evidence storage unit 210, the computer readable memory medium within which the structural information is stored is accessed by the processor 110 and a graphical diagram 420 is generated in response to the structural information by the processor 110. The graphical diagram 420 includes a root node 422 representing the outermost evidence storage unit 210. In one embodiment, the root node 422 includes a description 421 of the structural information for the outermost evidence storage unit 210 within a boundary box 423 defining the root node 422, as shown in FIG. 3. In one embodiment, the root node 422 is represented by an icon 430, as shown in FIG. 6. Icon 430 is either a representative image, which is not an actual image, or an actual image of the item being represented by the icon 430, which is either one of the evidence storage units 210, 220 or one of the items 222 or 224. In one embodiment, the description 421 is located near the icon 430, such as beside the icon 430, underneath the icon 430, or on the icon 430. If the root node 422 is represented by icon 430, the user may be prompted by the evidence documentation module 410 to either choose a representative image for the icon 430 or to provide and store an actual image of the item being represented by the icon 430 within the computer readable memory medium. If an actual image of the item being represented by the icon 430 is provided, then an icon 430 will be generated from that actual image by the processor 110.

Moving to block 308, upon generating the graphical diagram 420 and the root node 422, the user is then prompted to provide information as to all immediate content in the outermost evidence storage unit 210. Immediate content of the outermost evidence storage unit 210 includes any item 222 or 224 that is not contained within an evidence storage unit or any evidence storage unit 220 that is within the outermost evidence storage unit 210. If there is any inner storage unit 220 within the outermost evidence storage unit 210, the user is then prompted to input a number detailing how many inner evidence storage units 220 are within the outermost evidence storage unit 210, and then to provide structural information for each of the inner evidence storage unit 220.

At block 310, upon receiving the structural information for each of the inner evidence storage unit 220, the computer readable memory medium within which the structural information is stored is accessed by the processor 110 and a child node 424 of the root node 422 representing an inner evidence storage unit 220 is generated for each inner evidence storage units 220 and added to the graphical diagram 420. Additionally, a link 425 between the child node 424 and the root node 422 is generated and added to the graphical diagram 420 showing the relationship between the child node 424 and the root node 422. In one embodiment, the child node 424 includes a description 421 of the structural information for each inner evidence storage unit 220 within a boundary box 423 defining the child node 424, as shown in FIG. 3. In one embodiment, the child node 424 is represented by an icon 430, as shown in FIG. 6.

If there is any item 222 or 224 that is not contained within an evidence storage unit and is within the outermost evidence storage unit 210, the user is then prompted to input a number detailing how many items 222 or 224 are within the outermost evidence storage unit 210, and then to provide structural information for each of the items 222 or 224.

At block 312, upon receiving the structural information for each of the items 222 or 224, the computer readable memory medium within which the structural information is stored is accessed by the processor 110 and a leaf node 426 of the root node 422 representing an item 222 or 224 is generated for each item 222 or 224 and added to the graphical diagram 420. Leaf node 426 is a node which is connected to a parent node but no child node, and essentially represents an ending node. Additionally, a link 425 between the leaf node 426 and the root node 422 is generated and added to the graphical diagram 420 showing the relationship between the leaf node 426 and the root node 422. In one embodiment, the leaf node 426 includes a description 421 of the structural information for each item 222 or 224 within a boundary box 423 defining the leaf node 426, as shown in FIG. 3. In one embodiment, the leaf node 426 is represented by an icon 430, as shown in FIG. 6.

Moving to block 314, for each child node 424 generated and added to the graphical diagram 420, the user is then prompted to provide information as to all immediate content in each child node 424. If a child node 424 includes any item 222 or 224 that is not contained within an evidence storage unit, then a leaf node 426 is generated which is connected with the child node 424 through link 425. If a child node 424 includes any evidence storage unit 220, then another child node 424 is generated which is connected with the previous child node 424, now a parent node, through link 425. The process in block 314 is repeated until no more child nodes 424 remain, and the graphical diagram 420 ends with all leaf nodes 426, as shown in FIG. 3.

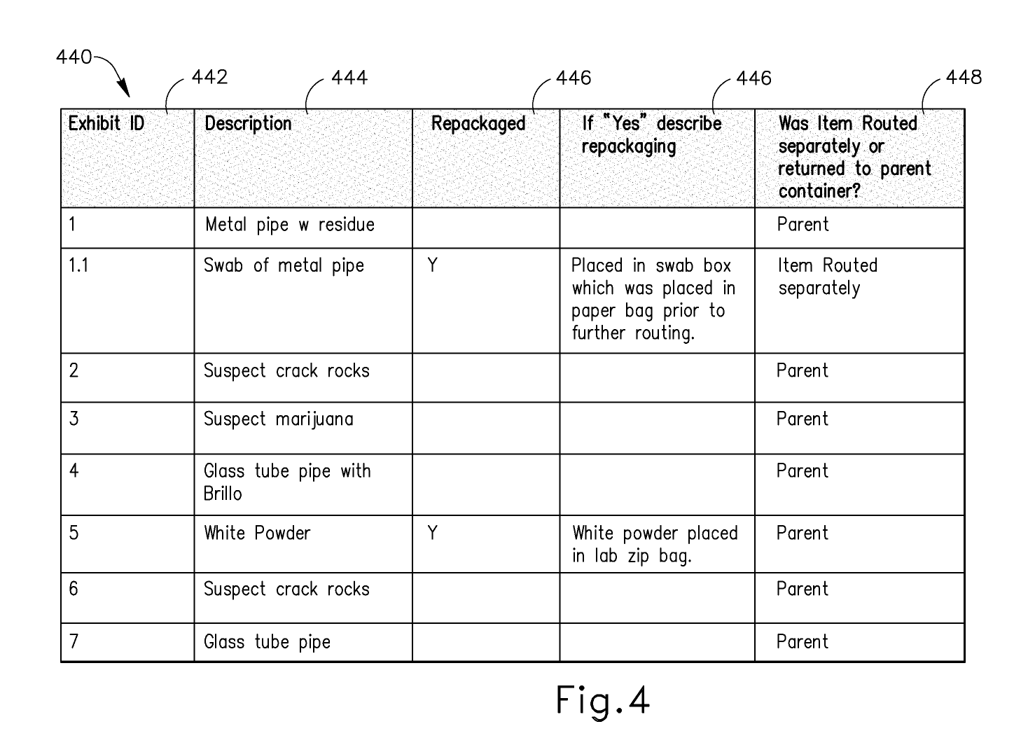

Moving to block 316, upon repeating the process in block 314 until no more child nodes 424 remain, each remaining leaf node 426 is pinged, or selected, and converted into a pinged leaf node 428. Each pinged leaf node 428 is then linked to an exhibit grid 440, wherein the exhibit grid 440 provides further information about the item of evidence 222 represented by the pinged leaf node 428. The exhibit grid 440 provides structural information about the item of evidence 222 which may include an exhibit ID 442 for each item of evidence 222, a description 444 of each item of evidence 222, repacking information 446 for each item of evidence 222, and item routing information for each item of evidence 222, as shown in FIG. 4. Preferably, the exhibit grid 440 is a tabular representation of every pinged leaf node 428. In one embodiment, selecting a pinged leaf node 428 prompts the evidence documentation module to display an exhibit grid 440 linked to the selected pinged leaf node 428, and display structural information regarding the item of evidence 222 represented by the selected pinged leaf node 428. Upon creating the pinged leaf node 428 and linked them to the exhibit grid 440, the method 300 then ends at block 318.

In this manner, by generating the graphical diagram 420 and the exhibit grid 440, the evidence documentation module is able to document enough structural information so as to recreate the evidence packaging structure 200 and provide a means for documenting the complete evidence packaging structure so that a forensic analyst may be able to later describe the complete evidence packaging structure at some later date. In one embodiment, upon generating the graphical diagram 420, the graphical diagram 420 is displayed on a display device connected with the computer 100.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats.

However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents.

1. A computer readable memory medium comprising program instructions for documenting an evidence packaging structure, wherein the program instructions are executable by a processor to:
generate a graphical diagram in response to user input, wherein the graphical diagram includes:
a root node representing an outermost evidence storage unit; and
a leaf node of the root node representing an item of evidence, wherein the item of evidence is located within the evidence storage unit.

2. The computer readable memory medium of claim 1 further comprising program instructions executable by a processor to display the graphical diagram, wherein each of the root node and the leaf node are represented by icons, and wherein each icon is either a representative image or an actual image of the evidence storage unit or the item of evidence.

3. The computer readable memory medium of claim 1 further comprising program instructions executable by a processor to:
ping a leaf node in response to user input, wherein upon pinging the leaf node, the leaf node displays a pinged icon; and
link a pinged leaf node to an exhibit grid, wherein the exhibit grid provides further information about the item of evidence represented by the pinged leaf node.

4. The computer readable memory medium of claim 3, wherein the exhibit grid is a tabular representation of every pinged leaf node.

5. The computer readable memory medium of claim 3, wherein the exhibit grid provides a description, repackaging information, and item routing information for the item of evidence represented by the pinged leaf node.

6. The computer readable memory medium of claim 1 further comprising program instructions executable by a processor to prompt a user to input a number of leaf nodes which are linked to a selected parent node or root node.

7. The computer readable memory medium of claim 1, wherein the graphical diagram includes a leaf node of the root node representing an additional storage unit located within the evidence storage unit.

8. A method for documenting an evidence packaging structure, comprising:
inputting structural information for an outermost evidence storage unit and each interior evidence storage unit and each item of evidence within the outermost evidence storage unit into a computer readable memory medium; and
accessing computer readable memory medium and generating, using a processor, a graphical diagram in response to the structural information, wherein the graphical diagram includes:
a root node representing the outermost evidence storage unit; and
a leaf node of the root node representing each item evidence within the outermost evidence storage.

9. The method of claim 8 further comprising displaying the graphical diagram, wherein each of the root node and the leaf node are represented by icons, and wherein each icon is either a representative image or an actual image of the evidence storage unit or the item of evidence.

10. The method of claim 8 further comprising:
pinging a leaf node in response to user input, wherein upon pinging the leaf node, the leaf node displays a pinged icon; and
link a pinged leaf node to an exhibit grid, wherein the exhibit grid provides further information about the item of evidence represented by the pinged leaf node.

11. The method of claim 10, wherein the exhibit grid is a tabular representation of every pinged leaf node.

12. The method of claim 10, wherein the exhibit grid provides a description, repackaging information, and item routing information for the item of evidence represented by the pinged leaf node.

13. The method of claim 8 further comprising prompting a user to input a number of leaf nodes which are linked to a selected parent node or root node.

14. A laboratory information management system for documenting an evidence packaging structure, comprising:
a computer readable memory medium; and
at least one processor operable to access from the computer readable memory medium program instructions executable by the processor to:
receive structural information input by a user into the computer readable memory medium, the structural information describing the relationship between an outermost evidence storage unit and each interior evidence storage unit and each item of evidence within the outermost evidence storage unit,
access the computer readable memory medium to retrieve the structural information, and
generate a graphical diagram in response to the structural information, wherein the graphical diagram includes a root node representing the outermost evidence storage unit and a leaf node of the root node representing each item evidence within the outermost evidence storage.

15. The system of claim 14, wherein the at least one processor is operable to access from the computer readable memory medium program instructions executable by the processor to display the graphical diagram, wherein each of the root node and the leaf node are represented by icons, and wherein each icon is either a representative image or an actual image of the evidence storage unit or the item of evidence.

16. The system of claim 14, wherein the at least one processor is operable to access from the computer readable memory medium program instructions executable by the processor to:
ping a leaf node in response to user input, wherein upon pinging the leaf node, the leaf node displays a pinged icon; and
link a pinged leaf node to an exhibit grid, wherein the exhibit grid provides further information about the item of evidence represented by the pinged leaf node.

17. The system of claim 16, wherein the exhibit grid is a tabular representation of every pinged leaf node.

18. The system of claim 16, wherein the exhibit grid provides a description, repackaging information, and item routing information for the item of evidence represented by the pinged leaf node.

19. The system of claim 14, wherein the at least one processor is operable to access from the computer readable memory medium program instructions executable by the processor to prompt a user to input a number of leaf nodes which are linked to a selected parent node or root node.

20. The system of claim 14, wherein the graphical diagram includes a leaf node of the root node representing an additional storage unit located within the evidence storage unit.
